(19) United States
(12) Patent Application Publication
(10) Pub. No.: US 2019/0214693 A1
(43) Pub. Date: Jul. 11, 2019

(54) ON-BOARD BATTERY TEMPERATURE REGULATING APPARATUS, THE ON-BOARD BATTERY TEMPERATURE REGULATING METHOD, AND NON-TRANSITORY TANGIBLE RECORDING MEDIUM STORING THEREIN ON-BOARD BATTERY TEMPERATURE REGULATING PROGRAM

(71) Applicant: Panasonic Intellectual Property Management Co., Ltd., Osaka (JP)

(72) Inventors: Takuma IIDA, Kanagawa (JP); Nobuaki SATOH, Kanagawa (JP); Keiji NISHIHARA, Kanagawa (JP)

(21) Appl. No.: 16/243,696

(22) Filed: Jan. 9, 2019

(30) Foreign Application Priority Data
Jan. 9, 2018 (JP) 2018-001464

(51) Int. Cl. H01M 10/617; H01M 10/637; H01M 10/6563; H01M 10/625; H01M 10/633

(52) U.S. Cl. CPC H01M 10/617; H01M 10/637; H01M 10/633; H01M 10/625; H01M 10/6563

(57) ABSTRACT

In order to secure the charge/discharge performance of an on-board battery in accordance with an external request, an on-board battery temperature regulating apparatus for regulating the temperature of the on-board battery that is charged or discharged based on a charge or discharge request from an external apparatus includes: a temperature regulator capable of regulating the temperature of the on-board battery; and a controller that determines a presence or absence of the charge or discharge request from an external apparatus to the on-board battery, and controls, when the charge or discharge request is determined to be present, the temperature regulator such that the temperature of the on-board battery is at least within a temperature range where the on-board battery is capable of being charged with or discharging requested power requested from the external apparatus.

### TECHNICAL FIELD

The present disclosure relates to an on-board battery temperature regulating apparatus, an on-board battery temperature regulating method, and a non-transitory tangible recording medium storing therein an on-board battery temperature regulating program for regulating the temperature of an on-board battery.

### BACKGROUND ART

Conventionally, ancillary services for maintaining power quality by sharing power within a power system have been known. The power system in each of the ancillary services includes a power generator, a power consumption apparatus, and a storage battery that can be charged or discharged. In the ancillary service, the storage battery is charged in a case of surplus power generation or is discharged (that is, the storage battery supplies power to the power consumption apparatus) in a case of excessive power consumption, so that load balancing between supply and demand is achieved and, thereby, the power quality in the power system is maintained.

### CITATION LIST

### Patent Literature

### PTL 1

### Japanese Patent Application Laid-Open No. 2017-093173

### SUMMARY OF INVENTION

### Technical Problem

It is thinkable to utilize in the ancillary service an on-board battery used in an Electric Vehicle (EV) or a Hybrid Electric Vehicle (HEV). The on-board battery can be charged or discharged by connecting each of these vehicles to the power system in the ancillary service.

In the meantime, great power is input and/or output for a short time in the ancillary service. Accordingly, a charge or discharge of great power is also required for the storage battery.

The charge/discharge performance of the storage battery (the amount of power that can be input to the storage battery when the storage battery is charged and the amount of power that can be output by the storage battery when the storage battery is discharged) changes depending on the temperature of the storage battery. Specifically, the charge/discharge performance of the storage battery is low in a state where the temperature of the storage battery is low or high. Moreover, the extent of deterioration of the storage battery is different depending on the temperature of the storage battery at the time of a charge or discharge of the storage battery. To be more specific, when the storage battery is charged or discharged in the state where the temperature of the storage battery is low or high, the deterioration of the storage battery is promoted.

The vehicle may be parked outside for a long time. In this case, the outside air temperature affects the temperature of the on-board battery greatly. For example, the temperature of the on-board battery may decrease with the decrease of the outside air temperature in winter. Further, in summer, the temperature of the on-board battery may increase due to the increase of the outside air temperature and/or by being exposed to direct sunlight.

When the on-board battery is charged or discharged at the request of the ancillary service in the state where the temperature of the on-board battery is low or high as mentioned above, the on-board battery may be incapable of being charged with or discharging power as requested. Moreover, such charging or discharging promotes the deterioration of the on-board battery.

The present disclosure is made in order to address such a problem, and an object of the present disclosure is to secure the charge/discharge performance of the on-board battery in accordance with an external request.

### Solution to Problem

One embodiment of the present disclosure is an on-board battery temperature regulating apparatus for regulating a temperature of an on-board battery to be charged or discharged based on a charge or discharge request from an external apparatus, and includes: a temperature regulator that regulates the temperature of the on-board battery; and a controller that determines a presence or absence of the charge or discharge request to the on-board battery, and controls, when the charge or discharge request is determined to be present, the temperature regulator such that the temperature of the on-board battery is at least within a temperature range where the on-board battery is capable of being charged with or discharging requested power requested from the external apparatus. Note that, one embodiment of the present disclosure may also be a method or a non-transitory tangible recording medium storing therein a program.

### Advantageous Effects of Invention

According to the present disclosure, it is possible to secure the charge/discharge performance of an on-board battery in accordance with an external request.

### BRIEF DESCRIPTION OF DRAWINGS

FIG. 1 is a block diagram schematically illustrating a vehicle in which an on-board battery temperature regulating apparatus according to an embodiment of the present disclosure is mounted and peripheral equipment;

FIG. 2 illustrates a map showing a relationship between the temperature of a battery and the upper limit value of charge/discharge power; and

FIG. 3 is a flowchart illustrating a flow of temperature regulating operation of the battery.

### DESCRIPTION OF EMBODIMENTS

Hereinafter, an embodiment of the present disclosure will be described in detail with reference to the accompanying drawings. Note that, the embodiment described below is an example and the present disclosure is not limited by this embodiment.

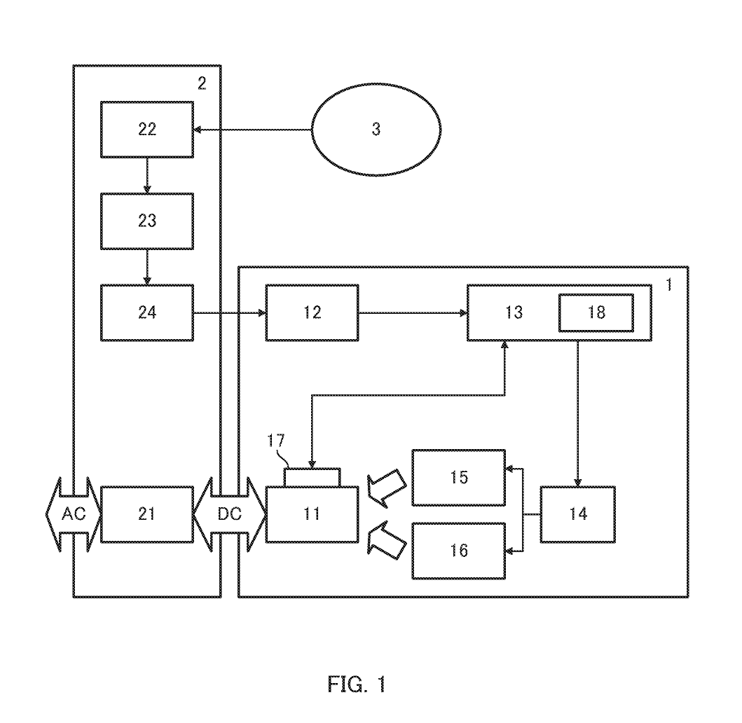

FIG. 1 is a block diagram schematically illustrating a vehicle in which an on-board battery temperature regulating apparatus according to the embodiment of the present disclosure is mounted and peripheral equipment. Battery 11 (one example of the “on-board battery”) is mounted in vehicle 1 such as an EV, HEV, or the like. In the present embodiment, vehicle 1 includes, in addition to battery 11, vehicle-side communicator 12, vehicle Electronic Control Unit (ECU) 13, temperature regulating ECU 14, Positive Temperature Coefficient (PTC) heater 15, and cooling fan 16. Temperature regulating ECU 14, PTC heater 15, and cooling fan 16 are an example of the “temperature regulator”.

Battery 11 is a lithium-ion battery, for example. Note that, battery 11 is not limited to the lithium-ion battery, but may also be a solid-state battery or the like. The capacity of battery 11 is tens of kWh, for example. Battery 11 is provided with Battery Management System (BMS) 17.

Battery 11 is electrically connectable to system cooperation apparatus 21 (described below) such as a power conditioner, storage battery, and/or the like in facility 2 (described below). Battery 11 is charged using a direct current from system cooperation apparatus 21. Battery 11 can also discharge to send a direct current to system cooperation apparatus 21.

The input/output of power between battery 11 and system cooperation apparatus 21 is performed using the direct current as described above. Thus, the fast charging of battery 11 from system cooperation apparatus 21 is possible, and the fast discharging from battery 11 to system cooperation apparatus 21 is also possible. BMS 17 detects the temperature of battery 11, State of Charge (SOC), and the like, and outputs them to vehicle ECU 13.

In addition, battery 11 is also electrically connected to a motor generator functioning as a traveling driving source of vehicle 1 and/or to various electrical components, so as to be used for supplying power to these devices. Note that, since the role of battery 11 as a power supply for the vehicle is the same as that traditionally taken, a detailed description of such a role is omitted.

Vehicle-side communicator 12 is capable of wirelessly communicating with facility-side communicator 24 (described below) provided in facility 2. A charge/discharge request signal or the like from the ancillary service that is output from facility-side communicator 24 is input to vehicle-side communicator 12. Vehicle-side communicator 12 outputs the signal to vehicle ECU 13.

Vehicle ECU 13 is connected to vehicle-side communicator 12, for example, via a Controller Area Network (CAN). Various signals, such as the charge/discharge request signal output from vehicle-side communicator 12 and the like, are input to vehicle ECU 13. Vehicle ECU 13 outputs, based on the charge/discharge request signal input from vehicle-side communicator 12, a control signal to BMS 17 such that battery 11 is charged or discharged. BMS 17 controls a relay (not illustrated) disposed on a power line connecting battery 11 provided in vehicle 1 to system cooperation apparatus 21, for example. Note that, although the present embodiment is described in relation to the example where BMS 17 controls the relay, the present disclosure is not limited to this example, and vehicle ECU 13 may control the relay, for example.

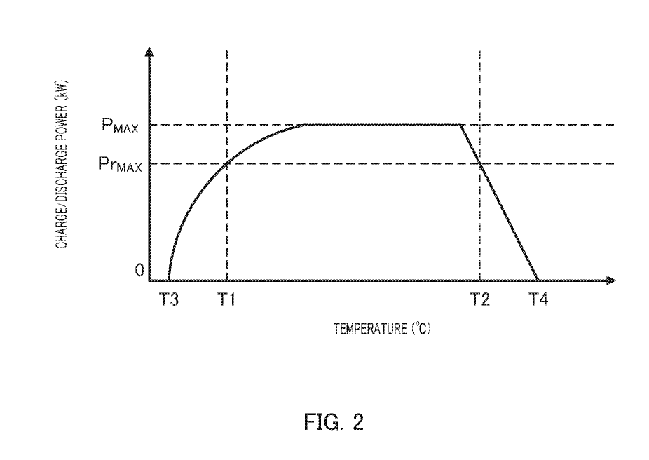

The temperature of battery 11 detected by BMS 17 is input into vehicle ECU 13 in real time. Moreover, a predefined relationship (see the map illustrated in FIG. 2) between the temperature of battery 11 and the upper limit value of charge/discharge power is stored in storage 18 of vehicle ECU 13.

Such a relationship is decided in consideration of the charge/discharge performance of battery 11 and the deterioration characteristics of battery 11. Specifically, when the temperature of battery 11 is low or high, the upper limit value of charge/discharge power is set to be low as illustrated in FIG. 2 since the amount of power which battery 11 can be charged with or can discharge is limited and the charge or discharge of great power promotes the deterioration of battery 11.

Vehicle ECU 13 determines a proper temperature range of battery 11 based on the aforementioned relationship and based on the charge/discharge power needed depending on situations. Then, vehicle ECU 13 outputs the control signal to temperature regulating ECU 14 in order that the temperature of battery 11 is within the aforementioned proper temperature range.

Based on the control signal from vehicle ECU 13, temperature regulating ECU 14 controls PTC heater 15 or cooling fan 16 to regulate the temperature of battery 11. Temperature regulating ECU 14 drives PTC heater 15 to increase the temperature of battery 11. Temperature regulating ECU 14 drives cooling fan 16 to decrease the temperature of battery 11. Note that, since PTC heater 15 and cooling fan 16 are well-known techniques, detailed descriptions of them are omitted.

Note also that, the devices for regulating the temperature of battery 11 are not limited to PTC heater 15 and cooling fan 16. For example, heat pump may be used as a heat source, or a combination of a heater and a fan may be used.

Facility 2 includes communicator 22 that communicates with apparatus 3 that controls the power system in the ancillary service, Home Energy Management System (HEMS) 23, facility-side communicator 24, and system cooperation apparatus 21.

A charge or discharge request to battery 11 is input from apparatus 3 in communicator 22. Such a charge or discharge request is transmitted to HEMS 23 from communicator 22, and is transmitted further to vehicle-side communicator 12 via facility-side communicator 24.

Additionally, information about a plan on power of the power system in the ancillary service (e.g., a plan to charge battery 11 on a predetermined date and time, on a day of the week, or in a time period) is input to communicator 22 from apparatus 3. Such information is also transmitted to vehicle-side communicator 12.

System cooperation apparatus 21 includes a power conditioner and/or a storage battery as described above, for example. System cooperation apparatus 21 receives an input of alternating current from the power system in the ancillary service, and outputs an alternating current to the power system in the ancillary service. That is, the input and output of power between system cooperation apparatus 21 and the power system in the ancillary service is provided using the alternating current.

Additionally, system cooperation apparatus 21 is connectable to battery 11 as described above. The input and output of power between system cooperation apparatus 21 and battery 11 is performed using the direct current.

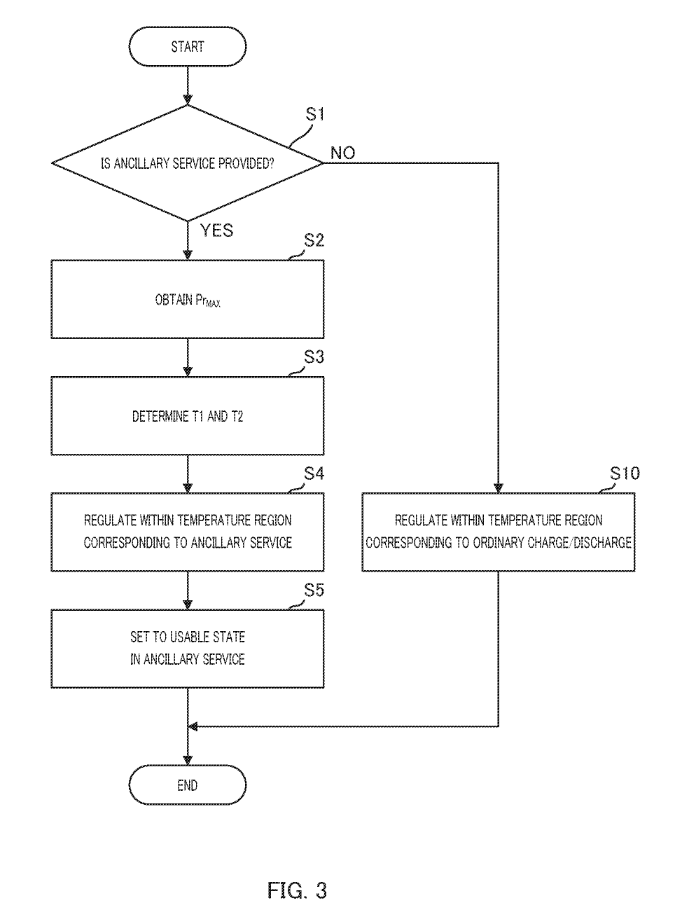

Next, with reference to FIG. 3, a description will be given of the details of temperature regulating operation of battery 11.

To begin with, vehicle ECU 13 determines at step S1 whether or not to provide the ancillary service. This determination is done in the following way, for example. Note that, “whether or not to provide the ancillary service” can be understood to mean “whether or not the charge or discharge request from outside vehicle 1 to battery 11 arises.”

Generally, the ancillary service is a service for regulating and stabilizing the frequency of a power system depending on power supply and demand situations. The generated power of the power system that influences the supply and demand situation of the power system that is one of factors of a frequency change is changed by a weather change. Therefore, the weather change serves as an important basis for determination of whether or not to provide the ancillary service.

Accordingly, vehicle ECU 13 may predict the weather change (that is, the change in generated power) based on information of a weather report or the like that can be obtained via vehicle-side communicator 12, for example, and may determine to provide the ancillary service when it is predicted that the weather changes.

Additionally or alternatively, vehicle ECU 13 may also determine whether or not to provide the ancillary service based on the aforementioned information about the plan on power of the power system in the ancillary service input from apparatus 3. It is possible to include, in such information, a date, a day of the week, a time period, and the like, and vehicle ECU 13 can determine to provide the ancillary service on a predetermined date, on a predetermined day of the week, or in a predetermined time period.

Further, vehicle ECU 13 may also determine to provide the ancillary service when vehicle 1 arrives at facility 2 belonging to the power system in the ancillary service and/or when battery 11 is connected to system cooperation apparatus 21 of facility 2.

When the ancillary service is determined not to be provided at step S1 (step S1: NO), processing proceeds to step S10. The details of the processing at step S10 will be described below.

Meanwhile, when the ancillary service is determined to be provided at step S1 (step S1: YES), the processing proceeds to step S2.

At step S2, vehicle ECU 13 obtains a maximum requested value (hereinafter, referred to as “maximum requested power Pr_{MAX}”) of charge/discharge power requested by the ancillary service.

At next step S3, vehicle ECU 13 sets, based on the map showing the relationship between the temperature and the upper limit value of charge/discharge power of battery 11, lower limit temperature T1 and upper limit temperature T2 (see the map illustrated in FIG. 2) of a temperature region of battery 11, in which region battery 11 can be charged with or can discharge maximum requested power Pr_{MAX} obtained at step S2.

Then, at step S4, vehicle ECU 13 outputs the control signal to temperature regulating ECU 14 such that the temperature of battery 11 is within temperature region between T1 and T2 set at step S3.

Specifically, when the temperature of battery 11 obtained from BMS 17 is lower than lower limit temperature T1, vehicle ECU 13 outputs the control signal to temperature regulating ECU 14 such that temperature regulating ECU 14 drives PTC heater 15 to increase the temperature of battery 11.

Additionally or alternatively, when the temperature of battery 11 obtained from BMS 17 is higher than upper limit temperature T2, vehicle ECU 13 outputs the control signal to temperature regulating ECU 14 such that temperature regulating ECU 14 drives cooling fan 16 to decrease the temperature of battery 11.

After the temperature of battery 11 is regulated at step S4 in this way to be within the temperature region where battery 11 can be charged with or can discharge maximum requested power Pr_{MAX}, the processing proceeds to step S5. Then, at step S5, vehicle ECU 13 outputs to BMS 17 the control signal for setting battery 11 such that battery 11 is in a usable state in the ancillary service, and the processing is ended.

At step S10 to which the processing proceeds in the case of determination of “NO” at step S1, vehicle ECU 13 regulates the temperature of battery 11 within a temperature region corresponding to an ordinary charge or discharge requested inside vehicle 1.

The “temperature region corresponding to an ordinary charge or discharge requested inside vehicle 1” means a temperature region where battery 11 can be charged or discharged, and is a region between ordinary lower limit temperature T3 and ordinary upper limit temperature T4 (see the map illustrated in FIG. 2). The range of such temperature region between T3 and T4 is wider than that of temperature region between T1 and T2 for regulation in the case where the ancillary service is provided.

When the ancillary service is not provided, BMS 17 controls the charge/discharge power such that the charge/discharge power does not exceed the upper limit value of charge/discharge power corresponding to the temperature of battery 11. This is a great difference as compared to the case where, when the ancillary service is provided, battery 11 needs to be charged with or to discharge the charge/discharge power requested by the ancillary service.

Thus, the temperature of battery 11 is regulated to be within the range of temperature region between T3 and T4 that is wider than temperature region between T1 and T2 when the ancillary service is not provided, so that a driving time of the temperature regulator is shorter than a driving time taken in the case where the ancillary service is provided.

As described above, according to the present embodiment, an on-board battery temperature regulating apparatus includes: a temperature regulator that regulates a temperature of an on-board battery; and a controller that determines a presence or absence of a charge or discharge request from an external apparatus to the on-board battery, and controls, when the charge or discharge request is determined to be present, the temperature regulator such that the temperature of the on-board battery is at least within a temperature range where the on-board battery is capable of being charged with or discharging requested power requested from the external apparatus.

With this configuration, it is possible to secure the charge/discharge performance of the on-board battery in accordance with an external request.

Note that, when the ancillary service is provided, the temperature of battery 11 is regulated to be within the temperature region where battery 11 can be charged with or can discharge maximum requested power Pr_{MAX} in the aforementioned embodiment, but the present disclosure is not limited to this embodiment.

In particular, the temperature of battery 11 may, for example, be regulated to be within a temperature region having a maximum value corresponding to the upper limit value of charge/discharge power of battery 11 (the maximum value may be referred to as maximum chargeable/dischargeable power P_{MAX} (see the map illustrated in FIG. 2)). Accordingly, it is possible to preferably reduce the deterioration of battery 11.

Note also that, the configuration in which the input and output of information is carried out between device 3 and vehicle 1 via facility 2 is employed in the aforementioned embodiment, the present disclosure is not limited to this embodiment. In particular, the input and output of information may also be carried out directly between device 3 and vehicle 1, for example.

While various embodiments have been described herein above, it is to be appreciated that various changes in form and detail may be made without departing from the spirit and scope of the invention(s) presently or hereafter claimed.

This application is entitled and claims the benefit of Japanese Patent Application No. 2018-001464, filed on Jan. 9, 2018, the disclosure of which including the specification, drawings and abstract is incorporated herein by reference in its entirety.

### INDUSTRIAL APPLICABILITY

According to an on-board battery temperature regulating apparatus, an on-board battery temperature regulating method, and a non-transitory tangible recording medium storing therein an on-board battery temperature regulating program according to the present disclosure, it is possible to secure the charge/discharge performance of an on-board battery in accordance with an external request, and therefore, the on-board battery temperature regulating apparatus, the on-board battery temperature regulating method, and the recording medium storing therein the on-board battery temperature regulating program according to the present disclosure are preferable for use in vehicles that provide ancillary services.

### REFERENCE SIGNS LIST

1 Vehicle
2 Facility
3 Apparatus
11 Battery
12 Vehicle-side communicator
13 Vehicle ECU
14 Temperature regulating ECU
15 PTC heater
16 Cooling fan
17 Battery management system (BMS)
18 Storage
21 System cooperation apparatus
22 Communicator
23 HEMS
24 Facility-side communicator

1. An on-board battery temperature regulating apparatus for regulating a temperature of an on-board battery to be charged or discharged based on a charge or discharge request from an external apparatus, the on-board battery temperature regulating apparatus comprising:
a temperature regulator that regulates the temperature of the on-board battery; and
a controller that determines a presence or absence of the charge or discharge request to the on-board battery, and controls, when the charge or discharge request is determined to be present, the temperature regulator such that the temperature of the on-board battery is at least within a temperature range where the on-board battery is capable of being charged with or discharging requested power requested from the external apparatus.

2. The on-board battery temperature regulating apparatus according to claim 1, wherein
the controller controls the temperature regulator such that the temperature of the on-board battery is within a temperature range where the on-board battery is capable of being charged with or discharging maximum requested power requested from the external apparatus.

3. The on-board battery temperature regulating apparatus according to claim 1, wherein
the controller controls the temperature regulator such that the temperature of the on-board battery is within a temperature range where the on-board battery is capable of being charged with or discharging maximum chargeable/dischargeable power of the on-board battery.

4. The on-board battery temperature regulating apparatus according to claim 1, wherein
the external apparatus is an apparatus that controls a power system in an ancillary service.

5. The on-board battery temperature regulating apparatus according to claim 4, wherein
the controller determines the presence or absence of the charge or discharge request based on a change in generated power of the power system in the ancillary service.

6. The on-board battery temperature regulating apparatus according to claim 5, wherein
the controller determines the presence or absence of the charge or discharge request based on a weather change.

7. The on-board battery temperature regulating apparatus according to claim 4, wherein
the controller determines the presence or absence of the charge or discharge request based on a plan on power of the power system in the ancillary service.

8. The on-board battery temperature regulating apparatus according to claim 7, wherein
the controller determines the presence or absence of the charge or discharge request based on at least one of a date, a day of a week, and a time period.

9. The on-board battery temperature regulating apparatus according to claim 4, wherein
the controller determines the presence or absence of the charge or discharge request based on whether or not a vehicle in which the on-board battery is mounted has arrived at a facility belonging to the power system in the ancillary service.

10. The on-board battery temperature regulating apparatus according to claim 4, wherein
the controller determines the presence or absence of the charge or discharge request based on whether or not a vehicle in which the on-board battery is mounted is connected to a system cooperation apparatus of a facility belonging to the power system in the ancillary service.

11. The on-board battery temperature regulating apparatus according to claim 1, wherein
the controller is provided in a vehicle in which the on-board battery is mounted.

12. The on-board battery temperature regulating apparatus according to claim 1, wherein
the temperature regulator includes at least a PTC heater or a cooling fan.

13. An on-board battery temperature regulating method for regulating a temperature of an on-board battery to be charged or discharged based on a charge or discharge request from an external apparatus, the on-board battery regulating method comprising:
determining a presence or absence of the charge or discharge request to the on-board battery; and
controlling, when the charge or discharge request is determined to be present, a temperature regulator that regulates the temperature of the on-board battery, the temperature regulator being controlled such that the temperature of the on-board battery is at least within a temperature range where the on-board battery is capable of being charged with or discharging requested power requested from the external apparatus.

14. A non-transitory tangible recording medium storing therein an on-board battery temperature regulating program for regulating a temperature of an on-board battery to be charged or discharged based on a charge or discharge request from an external apparatus, the on-board battery temperature regulating program causing a computer to perform processing comprising:
determining a presence or absence of the charge or discharge request to the on-board battery; and
controlling, when the charge or discharge request is determined to be present, a temperature regulator that regulates the temperature of the on-board battery, the temperature regulator being controlled such that the temperature of the on-board battery is at least within a temperature range where the on-board battery is capable of being charged with or discharging requested power requested from the external apparatus.
